(19) United States
(12) Patent Application Publication
(10) Pub. No.: US 2026/0120974 A1
(43) Pub. Date: Apr. 30, 2026

(54) KEYBOARD ASSEMBLY AND KEYBOARD DEVICE

(71) Applicant: DONGGUAN XUNMIN ELECTRONIC TECHNOLOGY CO., LTD., Dongguan City (CN)

(72) Inventor: JING CAI, Dongguan City (CN)

(73) Assignee: DONGGUAN XUNMIN ELECTRONIC TECHNOLOGY CO., LTD., Dongguan City (CN)

(21) Appl. No.: 19/432,872

(22) Filed: Dec. 24, 2025

(30) Foreign Application Priority Data
May 14, 2025 (CN) 202520942927.0

(51) Int. Cl. H01H 13/02; H01H 13/04; H01H 13/14; H01H 13/70

(52) U.S. Cl. CPC H01H 13/023; H01H 13/04; H01H 13/14; H01H 13/7006

(57) ABSTRACT

A keyboard assembly and a keyboard device are disclosed. The keyboard device includes a keyboard assembly and a support member. The keyboard module is provided with a surface shell and a key module, and the key module is connected to the surface shell; the key module is provided with at least one key, and a light-transmitting space is formed between the key and the surface shell; the light module is provided on one side of the key module, and the light emitted by the light module is projected along the light-transmitting space; the light module is provided with a plurality of lamp beads, which are independent of each other and can emit the same or different light.

### CROSS-REFERENCE TO RELATED APPLICATIONS

This application claims priority to Chinese Patent Application No. 202520942927.0, filed on May 14, 2025, the entire disclosures of which are incorporated herein by reference.

### TECHNICAL FIELD

The present application relates to the technical field of keyboard devices, in particular to a keyboard assembly and a keyboard device.

### BACKGROUND

With the development of technology, keyboard devices are widely used in people's lives. These keyboard devices are used to input commands and data for operating electronic equipment, and the keyboard assembly is an integral part of the keyboard device.

In the existing technology, the conventional keyboard assembly consists of a keyboard module, a light-guiding colloid, and a light module. The light-guiding colloid is positioned between the keyboard module and the light module, and the light module is built into the keyboard module. However, the light module relies on the light-guiding colloid for light transmission, which results in poor lighting effects of the existing keyboard assembly.

### SUMMARY

The purpose of this application is to provide a keyboard assembly and a keyboard device. The keyboard module is provided with a surface shell and a key module, and the key module is connected to the surface shell; the key module is provided with at least one key, and a light-transmitting space is formed between the key and the surface shell; the light module is provided on one side of the key module, and the light emitted by the light module is projected along the light-transmitting space; the light module is provided with a plurality of lamp beads, which are independent of each other and can emit the same or different light; the first circuit board is accommodated in the surface shell and electrically connected to the light module. This structure enables the plurality of lamp beads to transmit light through the light-transmitting space, thereby facilitating the provision of multiple light colors around the keys, avoiding the need for the light module to transmit light through a light-guiding colloid, improving the lighting effect of the keyboard assembly, and thus enhancing the usability of the keyboard assembly.

To achieve the above purpose, the present application provides the following technical solution: A keyboard assembly applied to a keyboard device, where the keyboard device is used for supporting electronic equipment, the keyboard assembly includes:

a keyboard module provided with a surface shell and a key module, wherein the key module is connected to the surface shell, the key module is provided with at least one key, and a light-transmitting space is formed between the at least one key and the surface shell; and a light module provided on one side of the key module, wherein light emitted by the light module is projected along the light-transmitting space, the light module is provided with a plurality of lamp beads, and the plurality of lamp beads are independent of each other and emit same or different light.

In one embodiment, the keyboard assembly further comprises a first circuit board, the first circuit board is accommodated in the surface shell and electrically connected to the light module; the light module comprises a second circuit board, the second circuit board is provided on one side of the plurality of lamp beads, and the plurality of lamp beads are all electrically connected to the second circuit board; the second circuit board is in an electrically connected state with the first circuit board; the second circuit board and the first circuit board are respectively a flexible circuit board (FCB) and/or a rigid circuit board (RCB).

In one embodiment, the second circuit board is connected with a conductive member, the conductive member is plugged into a docking end of the first circuit board, and both ends of the conductive member are respectively electrically connected to the second circuit board and the first circuit board; the conductive member is a flexible circuit board or a conductive wire.

In one embodiment, the lamp beads are red, green, blue(RGB) lamp beads, monochromatic light-emitting diode (LED) beads, multicolor LED beads or full-color LED beads; the second circuit board is provided with a plurality of conductive layers, and the plurality of conductive layers are electrically connected to corresponding lamp beads; the plurality of conductive layers are provided on a surface of the second circuit board and electrically connected to a bottom of the plurality of lamp beads.

In one embodiment, the light module comprises a light guide plate (LGP), the light guide plate is laid on a surface of the second circuit board, the light guide plate is provided with a plurality of through holes, and the plurality of through holes are respectively used for corresponding lamp beads to pass through; the plurality of lamp beads are positioned and connected with the plurality of through holes; the light guide plate is an acrylic plate or a polycarbonate (PC) plate; and the plurality of lamp beads either extend beyond the plurality of through holes or do not extend beyond the plurality of through holes.

In one embodiment, the light module further comprises a diffusion film, the diffusion film is laid on the light guide plate and covers the plurality of lamp beads;

the diffusion film is used for homogenizing the light emitted by the plurality of lamp beads or the light transmitted by the light guide plate; and

an accommodating space is formed between the diffusion film and the second circuit board, and the accommodating space is used for accommodating the light guide plate and the plurality of lamp beads.

In one embodiment, the key module is provided with a first positioning hole, the light module is provided with a second positioning hole, and the second positioning hole is provided relative to the first positioning hole and communicated with the first positioning hole;

the surface shell is provided with a positioning post, and the positioning post passes through the first positioning hole and the second positioning hole, so that the surface shell is positioned and connected to the key module and the light module; and the surface shell, the key module and the light module are provided in a stacked manner along a thickness direction of the keyboard assembly.

In one embodiment, the surface shell is provided with a plurality of support arms, the plurality of support arms are connected to each other and enclose to form a first through hole; the plurality of support arms are of an integrally formed structure; the at least one key is provided relative to the first through hole and is capable of stretching out and drawing back relative to the first through hole; a gap is formed between the at least one key and the plurality of support arms, and the gap forms part of the light-transmitting space; and the light-transmitting space is an annular space, a square space, an arc-shaped space or a special-shaped space; wherein the key module further comprises a support plate, a third circuit board and elastic gel; the support plate supports the third circuit board; the third circuit board is electrically connected to the first circuit board, the third circuit board is provided with key support arms, the elastic gel is provided relative to trigger ends of the key support arms, the at least one key is mounted on the elastic gel, and triggers the trigger ends of the key support arms during a pressing process; the support plate is provided with a second through hole, and the second through hole is communicated with the first through hole.

In one embodiment, the at least one key is provided opposite to the plurality of lamp beads, and at least one lamp bead is provided on one side of the at least one key; when the light emitted by two adjacent lamp beads is of the same color, the keyboard assembly has a first light mode; when the light emitted by two adjacent lamp beads is of different colors, the keyboard assembly has a second light mode; and the at least one key is provided with light-transmitting characters, and the light-transmitting characters are provided on one side of the plurality of lamp beads and used for displaying the light emitted by the plurality of lamp beads.

To achieve the above purpose, the present application provides the following technical solution: A keyboard device includes the keyboard assembly and a support member, wherein the support member is swingably connected to the keyboard assembly and can be adjusted in angle relative to the keyboard assembly; the support member is provided with a receiving slot, and the receiving slot is used for receiving the electronic equipment.

Compared with the related art, the beneficial effects of the present application are:

The present application provides a keyboard assembly and a keyboard device. The keyboard module is provided with a surface shell and a key module, and the key module is connected to the surface shell; the key module is provided with at least one key, and a light-transmitting space is formed between the key and the surface shell; the light module is provided on one side of the key module, and the light emitted by the light module is projected along the light-transmitting space; the light module is provided with a plurality of lamp beads, which are independent of each other and can emit the same or different light, to enable the plurality of lamp beads to transmit light through the light-transmitting space, thereby facilitating the provision of multiple light colors around the keys, avoiding the need for the light module to transmit light through a light-guiding colloid, improving the lighting effect of the keyboard assembly, and thus enhancing the usability of the keyboard assembly.

### BRIEF DESCRIPTIONS OF THE DRAWINGS

To more clearly illustrate the technical solutions in the embodiments of the present application, a brief introduction to the accompanying drawings required for describing the embodiments will be provided below. Obviously, the accompanying drawings described below are only some embodiments of the present application, and those skilled in the art can obtain other accompanying drawings based on these drawings without exerting creative efforts.

For a more complete understanding of the present application and its beneficial effects, the following description will be made in conjunction with the accompanying drawings. In the following description, the same reference numerals denote the same parts.

FIG. 1 shows a schematic diagram of a keyboard assembly according to an embodiment of the present application.

FIG. 2 shows a schematic diagram of an internal structure of the keyboard assembly according to an embodiment of the present application.

FIG. 3 shows a schematic diagram of a keyboard module of the keyboard assembly according to an embodiment of the present application.

FIG. 4 shows a schematic diagram of a light module of the keyboard assembly according to an embodiment of the present application.

FIG. 5 shows an exploded view of the light module of the keyboard assembly according to an embodiment of the present application.

FIG. 6 shows an exploded view of the key module of the keyboard assembly according to an embodiment of the present application.

FIG. 7 shows an enlarged partial view of part A in FIG. 6.

FIG. 8 shows a schematic diagram of a keyboard device according to an embodiment of the present application.

FIG. 9 shows a schematic diagram of a keyboard device according to another embodiment of the present application.

### DETAILED DESCRIPTIONS OF EMBODIMENTS

The following will clearly and completely describe the technical solutions in the embodiments of the present application with reference to the accompanying drawings in the embodiments of the present application. Obviously, the described embodiments are only a part of the embodiments of the present application, rather than all the embodiments. Based on the embodiments in the present application, all other embodiments obtained by those skilled in the art without creative work shall fall within the protection scope of the present application.

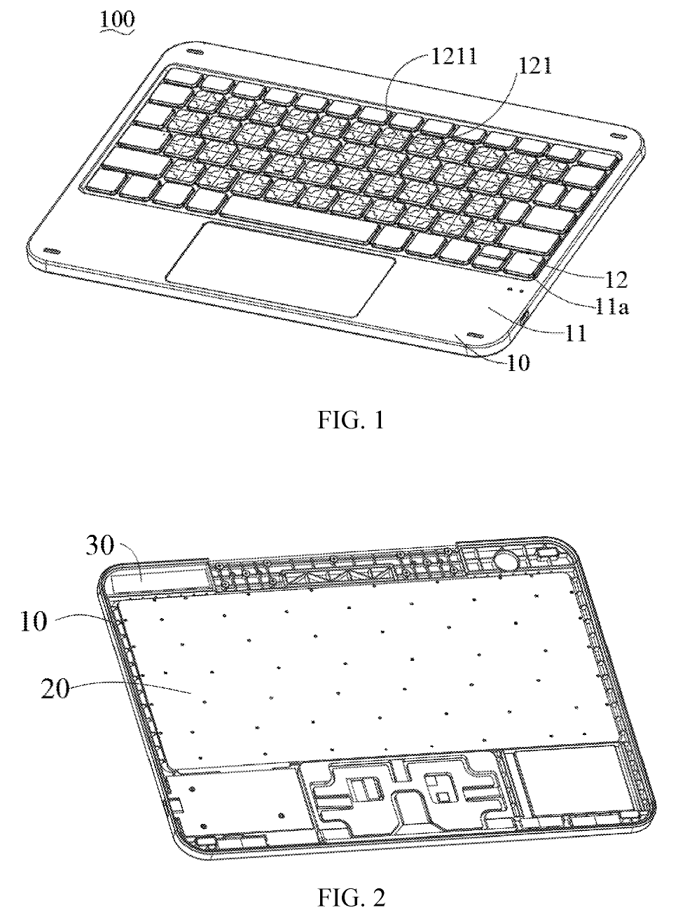

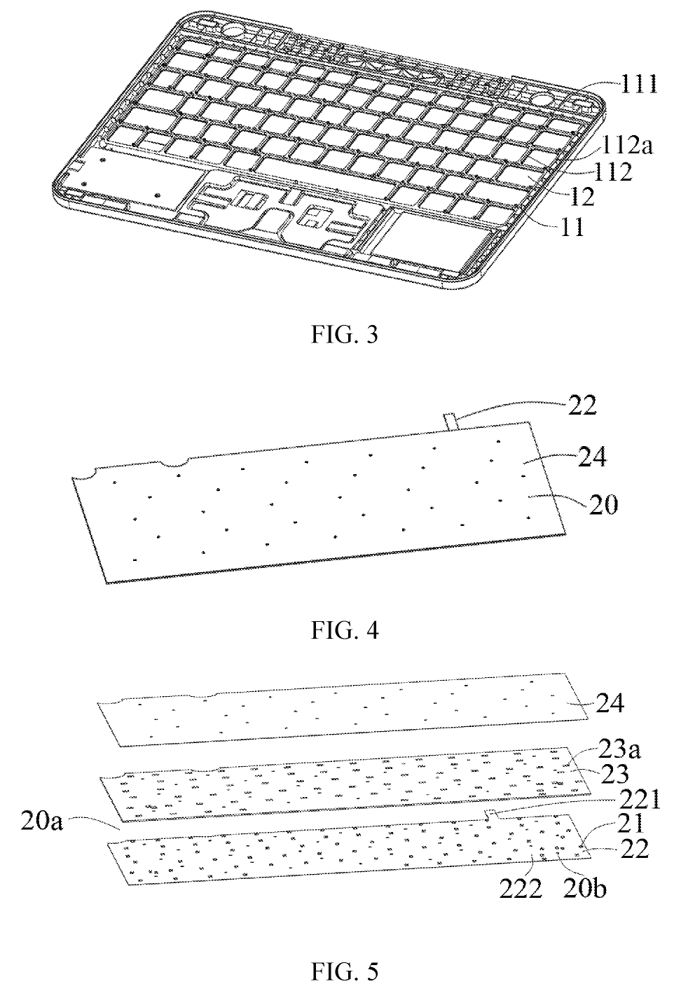

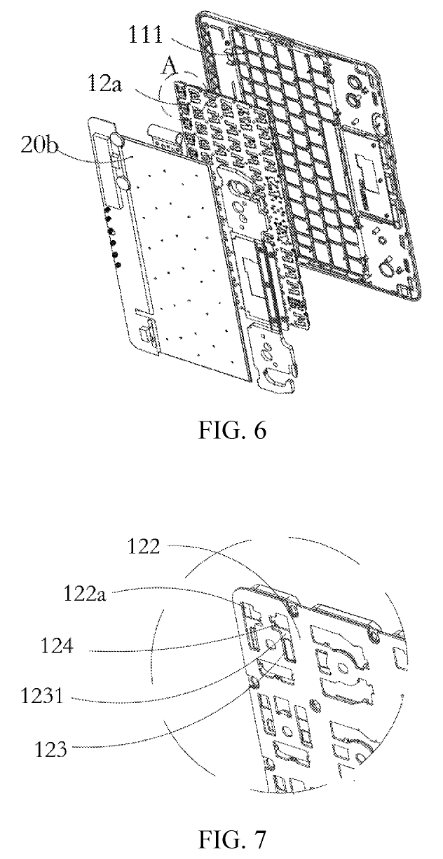

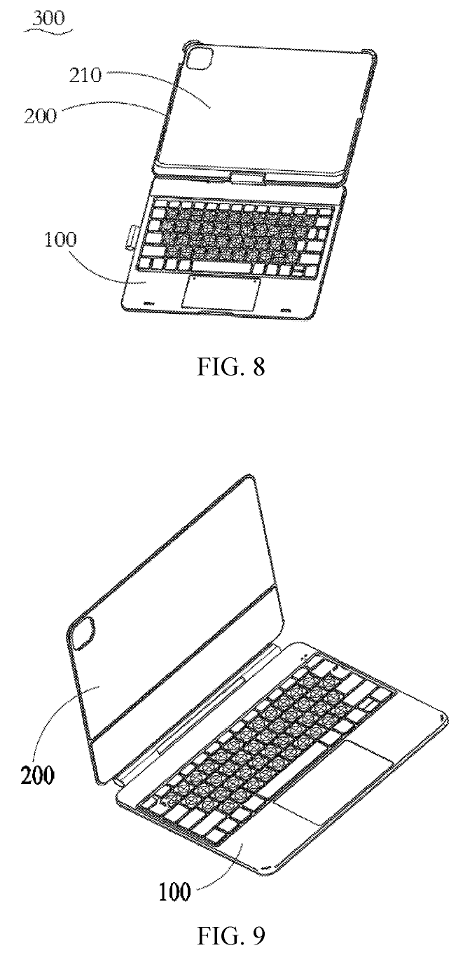

Please refer to FIGS. 1 to 8, an embodiment of the present application provides a keyboard assembly 100. The keyboard assembly 100 is applied to a keyboard device 300, and the keyboard assembly 100 is used to output multiple light colors.

Please refer to FIGS. 1 to 8, in the embodiment of the present application, the keyboard assembly 100 includes a keyboard module 10, a light module 20, and a first circuit board 30. The keyboard module 10 is provided with a surface shell 11 and a key module 12, and the key module 12 is connected to the surface shell 11. The key module 12 is provided with at least one key 121, and a light-transmitting space 11a is formed between the key 121 and the surface shell 11. The light module 20 is provided on one side of the key module 12, and the light emitted by the light module 20 is projected along the light-transmitting space 11a. The light module 20 is provided with a plurality of lamp beads 21, which are independent of each other and can emit the same or different light; the first circuit board 30 is accommodated in the surface shell 11 and electrically connected to the light module 20, so that the plurality of lamp beads 21 can transmit light through the light-transmitting space 11a, thereby facilitating the provision of multiple light colors around the key 121, avoiding the need for the light module 20 to transmit light through a light-guiding colloid, improving the lighting effect of the keyboard assembly 100, and thus enhancing the usability of the keyboard assembly 100.

Please refer to FIGS. 1 to 8, in the embodiment of the present application, the keyboard module 10 is provided with a surface shell 11 and a key module 12. The key module 12 is provided on a lower side of the surface shell 11, and the key module 12 is connected to the surface shell 11; the key module 12 is provided with at least one key 121, and a light-transmitting space 11a is formed between the key 121 and the surface shell 11; the light-transmitting space 11a is used for light to pass through.

The light module 20 is provided on a lower side of the key module 12, and the light emitted by the light module 20 is projected along the light-transmitting space 11a; the light module 20 is provided with a plurality of lamp beads 21, which are independent of each other and can emit the same or different light; this enables the plurality of lamp beads 21 to transmit light through the light-transmitting space 11a, thereby facilitating the provision of multiple light colors around the key 121, avoiding the need for the light module 20 to transmit light through a light-guiding colloid, improving the lighting effect of the keyboard assembly 100, and thus enhancing the usability of the keyboard assembly 100.

The first circuit board 30 is provided on an inner side of the keyboard module 10, and the first circuit board 30 is accommodated in the surface shell 11 to facilitate the fixing of the first circuit board 30 on the inner side of the surface shell 11. The first circuit board 30 is electrically connected to the light module 20 to facilitate the first circuit board 30 to provide signals to the light module 20, thereby enabling the light module 20 to switch between the on state and the off state.

Please refer to FIGS. 4 to 7, in the embodiment of the present application, the light module 20 includes a second circuit board 22. The second circuit board 22 is provided on a lower side of the plurality of lamp beads 21, and the plurality of lamp beads 21 are all electrically connected to the second circuit board 22 to facilitate the second circuit board 22 to provide signals to the plurality of lamp beads 21. The second circuit board 22 is electrically connected to the first circuit board 30 to enable the first circuit board 30 to be electrically connected to the plurality of lamp beads 21 through the second circuit board 22, thereby facilitating the first circuit board 30 to control the plurality of lamp beads 21 to switch between the on state and the off state. The second circuit board 22 and the first circuit board 30 are respectively a flexible circuit board (FCB) and/or a rigid circuit board (RCB). When the second circuit board 22 and the first circuit board 30 are respectively rigid circuit boards, the rigid circuit boards support the plurality of lamp beads 21 and provide stable physical support; the rigid circuit boards are usually made of hard materials and can bear the weight of the plurality of lamp beads 21 and various external forces. When the second circuit board 22 and the first circuit board 30 are respectively flexible circuit boards, the flexible circuit boards can be bent and folded. The flexible circuit boards can be bent without being damaged, and at the same time, can maintain the stability of the connection between the second circuit board 22 and the first circuit board 30 to ensure the normal transmission of signals.

Please refer to FIGS. 4 to 7, in the embodiment of the present application, the second circuit board 22 is connected with a conductive member 221, and the conductive member 221 is plugged into the docking end of the first circuit board 30 to facilitate the connection between the conductive member 221 and the first circuit board 30. Both ends of the conductive member 221 are respectively electrically connected to the second circuit board 22 and the first circuit board 30 to facilitate the first circuit board 30 to conduct electricity with the second circuit board 22 through the conductive member 221; the conductive member 221 is a flexible circuit board or a conductive wire.

Please refer to FIGS. 4 to 7, in the embodiment of the present application, the lamp beads 21 are RGB lamp beads, monochromatic LED beads, multicolor LED beads, or full-color LED beads; the second circuit board 22 is provided with a plurality of conductive layers 222, and the plurality of conductive layers 222 are electrically connected to the corresponding lamp beads 21; arranging a plurality of conductive layers 222 can adapt to lamp beads 21 with different characteristics, which helps to improve the reliability of the keyboard assembly 100. The plurality of conductive layers 222 are provided on the surface of the second circuit board 22 and electrically connected to the bottom of the lamp beads 21, which can provide stable electrical connection, reduce contact resistance, ensure that the current of the second circuit board 22 can be efficiently transmitted to the lamp beads 21, and help to extend the service life of the lamp beads 21 and the circuit board.

Please refer to FIGS. 4 to 7, in the embodiment of the present application, the light module 20 includes a light guide plate (LGP) 23. The light guide plate 23 is laid on a surface of the second circuit board 22, and the light guide plate 23 is provided with a plurality of through holes 23a. The plurality of through holes 23a are respectively used for corresponding lamp beads 21 to pass through, so that the light guide plate 23 can avoid the plurality of lamp beads 21 through the plurality of through holes 23a, preventing the light guide plate 23 from covering the light emitted by the plurality of lamp beads 21; the lamp beads 21 are positioned and connected to the through holes 23a, ensuring the positional accuracy between the light guide plate 23 and the lamp beads 21; the light guide plate 23 is an acrylic plate or a polycarbonate plate (PC plate); the acrylic plate or polycarbonate plate has crystal-like transparency and high light transmittance. The lamp beads 21 either extend beyond the through holes 23a or do not extend beyond the through holes 23a. When the lamp beads 21 extend beyond the through holes 23a, it helps to better dissipate the heat generated by the lamp beads 21 during operation, reduce the temperature of the lamp beads 21 themselves, and extend the service life of the lamp beads 21. When the lamp beads 21 do not extend beyond the through holes 23a, the thickness of the light guide plate 23 can be thinner.

Please refer to FIGS. 4 to 7, in the embodiment of the present application, the light module 20 further includes a diffusion film 24. The diffusion film 24 is laid on the light guide plate 23 and covers the plurality of lamp beads 21; the diffusion film 24 is used for homogenizing the light emitted by the plurality of lamp beads 21 or the light transmitted by the light guide plate 23 to enable the light emitted by the plurality of lamp beads 21 or the light transmitted by the light guide plate 23 to be transmitted to the external environment through the diffusion film 24 and the key 121, so that the light can be scattered on the surface of the diffusion film 24, and the light can be scattered softly and uniformly, improving the lighting effect of the keyboard assembly 100 and thus enhancing the usability of the keyboard assembly 100.

Please refer to FIGS. 4 to 7, an accommodating space 20a is formed between the diffusion film 24 and the second circuit board 22, and the accommodating space 20a is used for accommodating the light guide plate 23 and the plurality of lamp beads 21, so that the light guide plate 23 and the plurality of lamp beads 21 can make full use of the accommodating space 20a, and the light guide plate 23 and the plurality of lamp beads 21 are located between the diffusion film 24 and the second circuit board 22, thereby helping to reduce the space occupied between the diffusion film 24 and the second circuit board 22.

Please refer to FIGS. 1 to 8, in the embodiment of the present application, the key module 12 is provided with a first positioning hole 12a, the light module 20 is provided with a second positioning hole 20b, and the second positioning hole 20b is provided relative to the first positioning hole 12a and communicated with it.

The surface shell 11 is provided with a positioning post 111, and the positioning post 111 passes through the first positioning hole 12a and the second positioning hole 20b, so that the outer contour of the positioning post 111 is in contact with the inner contours of the first positioning hole 12a and the second positioning hole 20b, thereby facilitating the positioning post 111 to limit the positions of the first positioning hole 12a and the second positioning hole 20b, and enabling the surface shell 11 to be positioned and connected to the key module 12 and the light module 20; this ensures the positional accuracy between the surface shell 11, the key module 12, and the light module 20, and prevents positional deviation between the surface shell 11, the key module 12, and the light module 20. The surface shell 11, the key module 12, and the light module 20 are provided in a stacked manner along the thickness direction of the keyboard assembly 100, making full use of the thickness space of the keyboard assembly 100.

Please refer to FIGS. 1 to 9, in the embodiment of the present application, the surface shell 11 is provided with a plurality of support arms 112, which are connected to each other and enclose to form a first through hole 112a; the plurality of support arms 112 are of an integrally formed structure; the key 121 is provided relative to the first through hole 112a, so that the inner sidewall of the first through hole 112a can restrict the movement of the key 121 along the circumferential direction. The key 121 can stretch and retract relative to the first through hole 112a, and there is a gap between the key 121 and the support arms 112 to facilitate adjusting the height position of the key 121 relative to the first through hole 112a; the key 121 and the support arms 112 form part of the light-transmitting space 11a, so that the lamp beads 21 outputting different colors can realize different indicating functions through the light-transmitting space 11a; the light-transmitting space 11a is an annular space, a square space, an arc-shaped space, or a special-shaped space; the annular space, square space, arc-shaped space, and special-shaped space are used to indicate the function of the key 121.

The key module 12 further includes a support plate 122, a third circuit board 123, and elastic gel 124; the support plate 122 serves as a supporting component of the key module 12, and the support plate 122 is connected to the surface shell 11, so that the key module 12 can be connected to the surface shell 11 through the support plate 122. The support plate 122 supports the third circuit board 123 to facilitate the fixing of the third circuit board 123 on the support plate 122. The third circuit board 123 is electrically connected to the first circuit board 30, so that the key module 12 can be electrically connected to the first circuit board 30 through the third circuit board 123, thereby enabling signal transmission between the first circuit board 30 and the key module 12.

The third circuit board 123 is provided with key support arms 1231, and the elastic gel 124 is provided relative to the trigger ends of the key support arms 1231. The key 121 is mounted on the elastic gel 124 and triggers the trigger ends of the key support arms 1231 during the pressing process; this enables the key 121 to stretch and retract relative to the first through hole 112a through the elastic gel 124, thereby facilitating the key 121 to realize different functions during the pressing process. The support plate 122 is provided with a second through hole 122a, and the second through hole 122a is communicated with the first through hole 112a, so that the key 121 can stretch into the first through hole 112a through the second through hole 122a, thereby enabling the key 121 to make full use of the space of the second through hole 122a and the first through hole 112a.

In the embodiment of the present application, the key 121 is provided opposite to the lamp beads 21, and at least one lamp bead 21 is located on the lower side of the key 121; when the light emitted by two adjacent lamp beads 21 is of the same color, the keyboard assembly 100 has a first light mode; the same light color can make the keyboard assembly 100 present a harmonious and unified visual effect, enhancing the aesthetics and sense of immersion of the keyboard assembly 100.

When the light emitted by two adjacent lamp beads 21 is of different colors, the keyboard assembly 100 has a second light mode. The light of different colors can bring rich visual layering to the keyboard assembly 100, making the keyboard assembly 100 more visually attractive and dynamic.

Meanwhile, the key 121 is provided with light-transmitting characters 1211, and the light-transmitting characters 1211 are provided on one side of the lamp beads 21 and used for displaying the light emitted by the lamp beads 21.

In the second embodiment of the present application, a keyboard device 300 includes a keyboard assembly 100 and a support member 200. The keyboard assembly 100 is a part of the keyboard device 300, and the keyboard device 300 is used for supporting electronic equipment. The support member 200 is swingably connected to the keyboard assembly 100 and can be adjusted in angle relative to the keyboard assembly 100; the support member 200 is provided with a receiving slot 210, and the receiving slot 210 is used for receiving the electronic equipment.

In this case, the keyboard assembly 100 includes a keyboard module 10, a light module 20, and a first circuit board 30; the keyboard module 10 is provided with a surface shell 11 and a key module 12, and the key module 12 is connected to the surface shell 11; the key module 12 is provided with at least one key 121, and a light-transmitting space 11a is formed between the key 121 and the surface shell 11; the light module 20 is provided on one side of the key module 12, and the light emitted by the light module 20 is projected along the light-transmitting space 11a; the light module 20 is provided with a plurality of lamp beads 21, which are independent of each other and can emit the same or different light; the first circuit board 30 is accommodated in the surface shell 11 and electrically connected to the light module 20, so that the plurality of lamp beads 21 can transmit light through the light-transmitting space 11a, thereby facilitating the provision of multiple light colors around the key 121, avoiding the need for the light module 20 to transmit light through a light-guiding colloid, improving the lighting effect of the keyboard assembly 100, and thus enhancing the usability of the keyboard assembly 100.

Compared with the related art, the beneficial effects of the present application are: the present application provides a keyboard assembly 100 and a keyboard device 300. The keyboard module 10 is provided with a surface shell 11 and a key module 12, and the key module 12 is connected to the surface shell 11; the key module 12 is provided with at least one key 121, and a light-transmitting space 11a is formed between the key 121 and the surface shell 11; the light module 20 is provided on one side of the key module 12, and the light emitted by the light module 20 is projected along the light-transmitting space 11a; the light module 20 is provided with a plurality of lamp beads 21, which are independent of each other and can emit the same or different light; the first circuit board 30 is accommodated in the surface shell 11 and electrically connected to the light module 20, so that the plurality of lamp beads 21 can transmit light through the light-transmitting space 11a, thereby facilitating the provision of multiple light colors around the key 121, avoiding the need for the light module 20 to transmit light through a light-guiding colloid, improving the lighting effect of the keyboard assembly 100, and thus enhancing the usability of the keyboard assembly 100.

It should be noted that all directional indicators (such as up, down, left, right, front, rear...) in the embodiments of the present application are only used to explain the relative positional relationship and movement state between components in a specific posture. If the specific posture changes, the directional indicators will also change accordingly.

It should also be noted that when an element is referred to as being "fixed on" or "provided on" another element, it can be directly on the other element or there may be an intermediate element at the same time. When an element is referred to as being "connected" to another element, it can be directly connected to the other element or indirectly connected to the other element through an intermediate element.

In addition, the descriptions involving "first", "second", etc. in the present application are only for descriptive purposes, and cannot be understood as indicating or implying their relative importance or implicitly indicating the quantity of the indicated technical features. Therefore, the features defined with "first" and "second" may explicitly or implicitly include at least one such feature. In addition, the technical solutions between the various embodiments can be combined with each other, but must be based on the realization by those skilled in the art. When the combination of technical solutions is contradictory or cannot be realized, it should be considered that such a combination of technical solutions does not exist and is not within the protection scope required by the present application.

The above descriptions are only preferred embodiments of the present application, and do not therefore limit the patent scope of the present application. Any equivalent structural transformation made by using the contents of the description and drawings of the present application under the inventive concept of the present application, or direct/indirect application in other related technical fields, are all included in the patent protection scope of the present application.

What is claimed is:

1. A keyboard assembly, applied to a keyboard device, wherein the keyboard device is used for supporting electronic equipment and comprises a keyboard assembly and a support member;
the support member is swingably connected to the keyboard assembly and adjustable in angle relative to the keyboard assembly;
wherein the keyboard assembly comprises:
a keyboard module provided with a surface shell and a key module, wherein the key module is connected to the surface shell, the key module is provided with at least one key, and a light-transmitting space is formed between the at least one key and the surface shell; and
a light module provided on one side of the key module, wherein light emitted by the light module is projected along the light-transmitting space, the light module is provided with a plurality of lamp beads, and the plurality of lamp beads are independent of each other and emit same or different light.

2. The keyboard assembly according to claim 1, wherein the keyboard assembly further comprises a first circuit board, the first circuit board is accommodated in the surface shell and electrically connected to the light module;
the light module comprises a second circuit board, the second circuit board is provided on one side of the plurality of lamp beads, and the plurality of lamp beads are all electrically connected to the second circuit board; and
the second circuit board is in an electrically connected state with the first circuit board; the second circuit board and the first circuit board are respectively a flexible circuit board (FCB) and/or a rigid circuit board (RCB).

3. The keyboard assembly according to claim 2, wherein the second circuit board is connected with a conductive member, the conductive member is plugged into a docking end of the first circuit board, and both ends of the conductive member are respectively electrically connected to the second circuit board and the first circuit board; the conductive member is a flexible circuit board or a conductive wire.

4. The keyboard assembly according to claim 2, wherein the lamp beads are red, green, blue(RGB) lamp beads, monochromatic light-emitting diode (LED) beads, multicolor LED beads or full-color LED beads; the second circuit board is provided with a plurality of conductive layers, and the plurality of conductive layers are electrically connected to corresponding lamp beads; the plurality of conductive layers are provided on a surface of the second circuit board and electrically connected to a bottom of the plurality of lamp beads.

5. The keyboard assembly according to claim 2, wherein the light module comprises a light guide plate (LGP), the light guide plate is laid on a surface of the second circuit board, the light guide plate is provided with a plurality of through holes, and the plurality of through holes are respectively used for corresponding lamp beads to pass through;
the plurality of lamp beads are positioned and connected with the plurality of through holes;
the light guide plate is an acrylic plate or a polycarbonate (PC) plate; and
the plurality of lamp beads either extend beyond the plurality of through holes or do not extend beyond the plurality of through holes.

6. The keyboard assembly according to claim 5, wherein the light module further comprises a diffusion film, the diffusion film is laid on the light guide plate and covers the plurality of lamp beads;
the diffusion film is used for homogenizing the light emitted by the plurality of lamp beads or the light transmitted by the light guide plate; and
an accommodating space is formed between the diffusion film and the second circuit board, and the accommodating space is used for accommodating the light guide plate and the plurality of lamp beads.

7. The keyboard assembly according to claim 1, wherein the key module is provided with a first positioning hole, the light module is provided with a second positioning hole, and the second positioning hole is provided relative to the first positioning hole and communicated with the first positioning hole;
the surface shell is provided with a positioning post, and the positioning post passes through the first positioning hole and the second positioning hole; and
the surface shell, the key module and the light module are provided in a stacked manner along a thickness direction of the keyboard assembly.

8. The keyboard assembly according to claim 2, wherein the surface shell is provided with a plurality of support arms, the plurality of support arms are connected to each other and enclose to form a first through hole;
the plurality of support arms are of an integrally formed structure; the at least one key is provided relative to the first through hole and is capable of stretching out and drawing back relative to the first through hole;
a gap is formed between the at least one key and the plurality of support arms, and the gap forms part of the light-transmitting space; and
the light-transmitting space is an annular space, a square space, an arc-shaped space or a special-shaped space;
wherein the key module further comprises a support plate, a third circuit board and elastic gel; the support plate supports the third circuit board; the third circuit board is electrically connected to the first circuit board, the third circuit board is provided with key support arms, the elastic gel is provided relative to trigger ends of the key support arms, the at least one key is mounted on the elastic gel, and triggers the trigger ends of the key support arms during a pressing process;
the support plate is provided with a second through hole, and the second through hole is communicated with the first through hole.

9. The keyboard assembly according to claim 1, wherein the at least one key is provided opposite to the plurality of lamp beads, and at least one lamp bead is provided on one side of the at least one key;
when the light emitted by two adjacent lamp beads is of the same color, the keyboard assembly has a first light mode;
when the light emitted by two adjacent lamp beads is of different colors, the keyboard assembly has a second light mode; and
the at least one key is provided with light-transmitting characters, and the light-transmitting characters are provided on one side of the plurality of lamp beads and used for displaying the light emitted by the plurality of lamp beads.

10. The keyboard assembly according to claim 2, wherein when the second circuit board and the first circuit board are respectively rigid circuit boards, the rigid circuit boards support the plurality of lamp beads and provide stable physical support;
the rigid circuit boards are usually made of hard materials and bear a weight of the plurality of lamp beads and various external forces; or,
when the second circuit board and the first circuit board are respectively flexible circuit boards, the flexible circuit boards are capable of being bent and folded; the flexible circuit boards are capable of being bent without being damaged, and are capable of maintaining a stability of a connection between the second circuit board and the first circuit board to ensure a normal transmission of signals.

11. A keyboard assembly, applied to a keyboard device, wherein the keyboard device is used for supporting electronic equipment;
wherein the keyboard assembly comprises:
a keyboard module provided with a surface shell and a key module, wherein the key module is connected to the surface shell; the key module is provided with at least one key, and a light-transmitting space is formed between the at least one key and the surface shell; and
a light module provided on one side of the key module, wherein light emitted by the light module is projected along the light-transmitting space; the light module is provided with a plurality of lamp beads, and the plurality of lamp beads are independent of each other and emit same or different light.

12. The keyboard assembly according to claim 11, wherein the at least one key is provided opposite to the plurality of lamp beads, and at least one lamp bead is provided on one side of the at least one key;
when the light emitted by two adjacent lamp beads is of the same color, the keyboard assembly has a first light mode; and
when the light emitted by two adjacent lamp beads is of different colors, the keyboard assembly has a second light mode.

13. The keyboard assembly according to claim 11, wherein the at least one key is provided with light-transmitting characters, and the light-transmitting characters are provided on one side of the plurality of lamp beads and used for displaying the light emitted by the plurality of lamp beads.

14. The keyboard assembly according to claim 11, wherein the keyboard assembly further comprises a first circuit board, the first circuit board is accommodated in the surface shell and electrically connected to the light module;
the light module comprises a second circuit board, the second circuit board is provided on one side of the plurality of lamp beads, and the plurality of lamp beads are all electrically connected to the second circuit board; and
the second circuit board is in an electrically connected state with the first circuit board; the second circuit board and the first circuit board are respectively a flexible circuit board (FCB) and/or a rigid circuit board (RCB);
wherein the second circuit board is connected with a conductive member, the conductive member is plugged into a docking end of the first circuit board, and both ends of the conductive member are respectively electrically connected to the second circuit board and the first circuit board; the conductive member is a flexible circuit board or a conductive wire.

15. The keyboard assembly according to claim 14, wherein the lamp beads are red, green, blue(RGB) lamp beads, monochromatic light-emitting diode (LED) beads, multicolor LED beads or full-color LED beads; the second circuit board is provided with a plurality of conductive layers, and the plurality of conductive layers are electrically connected to corresponding lamp beads; the plurality of conductive layers are provided on a surface of the second circuit board and electrically connected to a bottom of the plurality of lamp beads.

16. The keyboard assembly according to claim 13, wherein the light module comprises a light guide plate (LGP), the light guide plate is laid on a surface of the second circuit board, the light guide plate is provided with a plurality of through holes, and the plurality of through holes are respectively used for corresponding lamp beads to pass through;
the plurality of lamp beads are positioned and connected with the plurality of through holes;
the light guide plate is an acrylic plate or a polycarbonate (PC) plate; and
the plurality of lamp beads either extend beyond the plurality of through holes or do not extend beyond the plurality of through holes;
wherein the light module further comprises a diffusion film, the diffusion film is laid on the light guide plate and covers the plurality of lamp beads;
the diffusion film is used for homogenizing the light emitted by the plurality of lamp beads or the light transmitted by the light guide plate; and
an accommodating space is formed between the diffusion film and the second circuit board, and the accommodating space is used for accommodating the light guide plate and the plurality of lamp beads.

17. A keyboard device, comprising the keyboard assembly according to claim 11 and a support member, wherein the support member is swingably connected to the keyboard assembly and can be adjusted in angle relative to the keyboard assembly; the support member is provided with a receiving slot, and the receiving slot is used for receiving the electronic equipment.

18. The keyboard device according to claim 17, wherein the at least one key is provided opposite to the plurality of lamp beads, and at least one lamp bead is provided on one side of the at least one key;
when the light emitted by two adjacent lamp beads is of the same color, the keyboard assembly has a first light mode; and
when the light emitted by two adjacent lamp beads is of different colors, the keyboard assembly has a second light mode.

19. The keyboard device according to claim 17, wherein the at least one key is provided with light-transmitting characters, and the light-transmitting characters are provided on one side of the plurality of lamp beads and used for displaying the light emitted by the plurality of lamp beads.

20. The keyboard device according to claim 17, wherein the keyboard assembly further comprises a first circuit board, the first circuit board is accommodated in the surface shell and electrically connected to the light module;
the light module comprises a second circuit board, the second circuit board is provided on one side of the plurality of lamp beads, and the plurality of lamp beads are all electrically connected to the second circuit board;
the second circuit board is in an electrically connected state with the first circuit board; the second circuit board and the first circuit board are respectively a flexible circuit board (FCB) and/or a rigid circuit board (RCB);
the surface shell is provided with a plurality of support arms, the plurality of support arms are connected to each other and enclose to form a first through hole;
the plurality of support arms are of an integrally formed structure; the at least one key is provided relative to the first through hole and is capable of stretching out and drawing back relative to the first through hole;
a gap is formed between the at least one key and the plurality of support arms, and the gap forms part of the light-transmitting space; and
the light-transmitting space is an annular space, a square space, an arc-shaped space or a special-shaped space;
wherein the key module further comprises a support plate, a third circuit board and elastic gel; the support plate supports the third circuit board; the third circuit board is electrically connected to the first circuit board, the third circuit board is provided with key support arms, the elastic gel is provided relative to trigger ends of the key support arms, the at least one key is mounted on the elastic gel, and triggers the trigger ends of the key support arms during a pressing process.
